(19) United States
(12) Patent Application Publication
(10) Pub. No.: US 2025/0159542 A1
(43) Pub. Date: May 15, 2025

(54) POLICY PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Yang SHEN, Beijing (CN); Jianfeng QI, Beijing (CN); Jinhua WU, Beijing (CN)

(21) Appl. No.: 18/832,211

(22) PCT Filed: Jan. 28, 2022
(86) PCT No.: PCT/CN2022/074799

§ 371 Date: Jul. 23, 2024

(51) Int. Cl. H04W 28/02; H04W 28/08

(52) U.S. Cl. CPC H04W 28/0268; H04W 28/0925

(57) ABSTRACT

A policy processing method is performed by a first network element, and includes: determining a policy related to user equipment (UE) according to physical state information of the UE.

### CROSS REFERENCE TO RELATED APPLICATION

This application is a U.S. National Stage of International Application No. PCT/CN2022/074799, filed on Jan. 28, 2022, the content of which is incorporated by reference herein in its entireties.

### TECHNICAL FIELD

This disclosure relates to, but is not limited to, the technical field of wireless communication, and in particular relates to policy processing methods and apparatuses, a communication device, and a storage medium.

### BACKGROUND

The policy and charging (or billing) control framework can be used to perform one or more of the following functions:
flow-based network usage charging function, which may include: online credit control and charging control on service data flow:
policy control on service data flow and session management, where the policy control can be used for quality of service (QOS) control and/or switch control of service data flow:
policy associated with UE access and mobility management, the access and mobility related policy can be used for mobility management and/or network access control of UE; and
management of user equipment (UE) policy information.

### SUMMARY

Embodiments of this disclosure provide policy processing methods and apparatuses, a communication device, and a storage medium.

According to a first aspect of embodiments of this disclosure, a policy processing method performed by a first network element is provided and includes:
determining a policy related to UE according to physical state information of the UE.

According to a second aspect of embodiments of this disclosure, a policy processing method performed by a second network element is provided and includes:
sending, when determining that physical state information of UE changes, a state information event to a first network element, where the physical state information indicated by the state information event is used by the first network element to determine a policy related to the UE.

According to a third aspect of embodiments of this disclosure, a policy processing method performed by UE is provided and includes:
monitoring physical state information of the UE; and
reporting, when the physical state information meets a policy update condition, the physical state information to a second network element, where the physical state information is to be forwarded by the second network element to a first network element and used by the first network element to determine a policy related to the UE.

According to a fourth aspect of embodiments of this disclosure, a communication device is provided and includes a processor, a transceiver, a memory and an executable program stored on the memory and to be run by the processor, where the processor is configured to, upon running the executable program, implement the policy processing method as described above.

It should be understood that both the foregoing general description and the following detailed description are exemplary and explanatory only, and are not intended to limit the embodiments of this disclosure.

### BRIEF DESCRIPTION OF THE DRAWINGS

The accompanying drawings, which are incorporated in and constitute a part of this specification, illustrate embodiments consistent with the present invention and together with the description serve to explain principles of the embodiments of the present invention.

FIG. 1 is a schematic structural diagram of a wireless communication system according to an exemplary embodiment.

FIG. 2 is a schematic diagram of a system architecture of a policy and charging control framework according to an exemplary embodiment.

FIG. 3 is a schematic diagram of the system architecture of a policy and charging control framework for non-roaming users according to an exemplary embodiment.

FIG. 4 is a schematic flowchart of a policy processing method according to an exemplary embodiment.

FIG. 5 is a schematic flowchart of a policy processing method according to an exemplary embodiment.

FIG. 6 is a schematic flowchart of a policy processing method according to an exemplary embodiment.

FIG. 7 is a schematic flowchart of a policy processing method according to an exemplary embodiment.

FIG. 8 is a schematic flowchart of a policy processing method according to an exemplary embodiment.

FIG. 9 is a schematic flowchart of a policy processing method according to an exemplary embodiment.

FIG. 10 is a schematic structural diagram of a policy processing apparatus according to an exemplary embodiment.

FIG. 11 is a schematic structural diagram of a policy processing apparatus according to an exemplary embodiment.

FIG. 12 is a schematic structural diagram of a policy processing apparatus according to an exemplary embodiment.

FIG. 13 is a schematic structural diagram of a policy processing apparatus according to an exemplary embodiment.

FIG. 14 is a schematic structural diagram of a UE according to an exemplary embodiment.

FIG. 15 is a schematic structural diagram of a communication device according to an exemplary embodiment.

### DETAILED DESCRIPTION

Reference will now be made in detail to the exemplary embodiments, examples of which are illustrated in the accompanying drawings. Where the following description refers to the accompanying drawings, the same numerals in different drawings refer to the same or similar elements unless otherwise indicated. The implementations described in the following exemplary embodiments do not represent all implementations consistent with the embodiments of this disclosure. Rather, they are merely examples of apparatuses and methods consistent with aspects of the disclosed embodiments as recited in the appended claims.

Terms used in the embodiments of this disclosure are for the purpose of describing specific embodiments only, and are not intended to limit the embodiments of this disclosure. As used in the examples of this disclosure and the appended claims, the singular forms “a” and “the” are also intended to include the plural forms unless the context clearly dictates otherwise. It should also be understood that the term “and/or” as used herein refers to and includes any and all possible combinations of one or more of the associated listed items.

It should be understood that although the embodiments of this disclosure may use the terms “first”, “second”, “third”, etc. to describe various information, the information should not be limited to these terms. These terms are only used to distinguish information of the same type from one another. For example, without departing from the scope of the embodiments of this disclosure, first information may also be called second information, and similarly, second information may also be called first information. Depending on the context, the word “if” as used herein may be interpreted as “upon” or “when” or “in response to determining that . . . .”

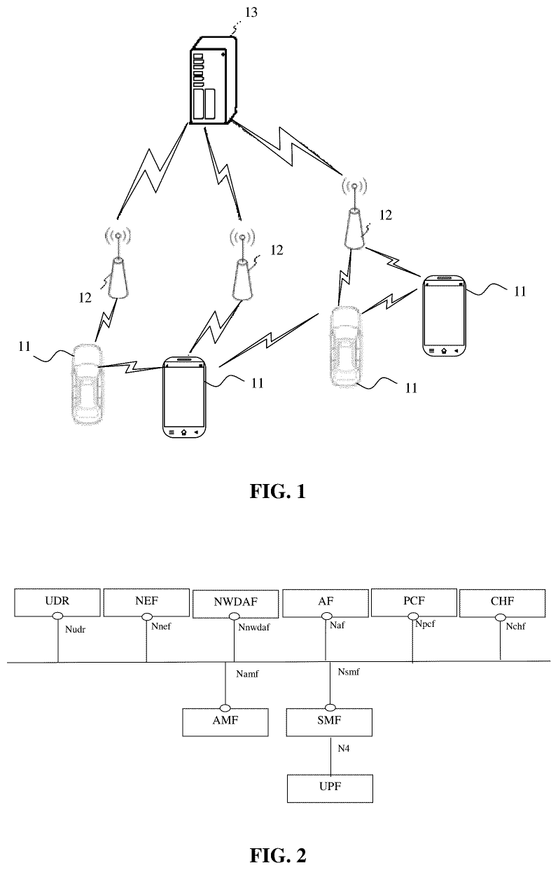

Referring to FIG. 1, which shows a schematic structural diagram of a wireless communication system according to an embodiment of this disclosure. As shown in FIG. 1, the wireless communication system is a communication system based on cellular mobile communication technology, and the wireless communication system may include: several UEs 11 and several base stations 12.

In some embodiments, UE 11 may be a device that provides voice and/or data connectivity to the user. UE 11 can communicate with one or more core networks via a radio access network (RAN), and UE 11 can be an Internet of things (IoT) UE, such as a sensor device, a mobile phone (or called “cellular” phone), and a computer with an IoT UE. For example, it may be a fixed, portable, pocket, hand-held, computer built-in, or vehicle-mounted device, such as station (STA), subscriber unit, subscriber station, mobile station, mobile, remote station, access point, remote terminal, access terminal, user terminal, user agent, user device, or user equipment. Alternatively, UE 11 may also be equipment of an unmanned aerial vehicle. Alternatively, UE 11 may also be a vehicle-mounted device, for example, a trip computer with a wireless communication function, or a wireless user device connected externally to the trip computer. Alternatively, UE 11 may also be a roadside device, for example, a street lamp, a signal lamp, or other roadside devices with a wireless communication function.

The base station 12 may be a network side device in the wireless communication system. In some embodiments, the wireless communication system may be the 4th generation mobile communication (4G) system, also known as the Long Term Evolution (LTE) system. Alternatively, the wireless communication system may also be the 5G system, also known as new air interface system or 5G NR system. Alternatively, the wireless communication system may also be a next-generation system of the 5G system. In some embodiments, the access network in the 5G system can be called NG-RAN (New Generation-Radio Access Network). Alternatively, the wireless communication system may also be MTC (Machine Type Communication) system.

In some embodiments, the base station 12 may be an evolved node-B (eNB) adopted in the 4G system. Alternatively, the base station 12 may also be a gNB adopting a centralization-distributed architecture in the 5G system. When the base station 12 adopts the centralization-distributed architecture, it generally includes a central unit (CU) and at least two distributed units (DUs). The CU is provided with a packet data convergence protocol (PDCP) layer, a radio link layer (RLC) protocol layer, a media access control (MAC) layer protocol stack; and the DU is provided with a physical (PHY) layer protocol stack. Embodiments of this disclosure do not limit the specific implementation of the base station 12.

A wireless connection may be established between the base station 12 and UE 11 through a wireless air interface. In different embodiments, the wireless air interface is a wireless air interface based on the 4G standard: alternatively, the wireless air interface is a wireless air interface based on the 5G standard, for example, a new air interface: alternatively, the wireless air interface may also be a wireless air interface based on a technical standard of a next-generation mobile communication network based on 5G.

In some embodiments, an E2E (End to End) connection may also be established between UEs 110, for example, in the scenarios including V2V (vehicle to vehicle) communication, V2I (vehicle to Infrastructure) communication and V2P (vehicle to pedestrian) communication in V2X (vehicle to everything) communication.

In some embodiments, the foregoing wireless communication system may further include a network management device 13.

FIG. 2 shows a policy and charging control framework, which may include:

PCF (Policy Control Function), SMF (Session Management Function), UPF (User Plane Function), AMF (Access and Mobility Management), NEF (Network Exposure Function), NWDAF (Network Data Analytics Function), CHF (Charging Function), AF (Application Function), and UDR (Unified Data Repository). Nudr, Nnef, Nnwdaf, Namf, Naf, Npcf, Nchf, Nsmf and N4 in FIG. 2 are interfaces between related network elements.

FIG. 3 shows a non-roaming policy and charging control architecture in the 5G network, which may include:

AF, NWDAF, UDR, NEF, CHF, PCF, AMF, SMF, and UPF. Herein, N4, N5, N7, N15, N23, N28, N29, N30, N36 and N40 shown in FIG. 3 are interfaces between corresponding network elements.

PCF provides authorized QoS for service data flow, and provides control of service data flow detection, gate control (switch), QoS and charging (except credit management) for SMF.

PCF calculates appropriate QoS authorization by using service information received from AF and/or subscription information received from UDR. The QoS authorization relates to QoS class identifiers and/or bit rates. The PCF will also consider determining appropriate QoS authorization for UE based on requested QoS received from SMF and analysis information received from NWDAF.

PCF can also detect consistencies between service information provided by AF and a policy defined by an operator and between the service information and the subscription data received from UDR during establishment of PDU (Protocol Data Unit) session. When the service information received from AF is inconsistent with the policy defined or indicated by the operator and/or with the subscription data received from UDF, PCF can reject the service information provided by AF. Otherwise, PCF can accept the service information provided by AF.

PCF should accept input from SMF, AMF, CHF, NWDAF (if present), UDR and AF (if present), and PCF can also use its own predefined information for policy and charging control (PCC) decision making. These different nodes should provide as much information as possible to PCF. In this way, PCF can provide a more suitable policy for UE.

In relevant policy control, the physical state information of UE, such as battery life and/or battery level, temperature, memory usage, and the like have never been considered.

XR (extended Reality)/media streaming has requirements on high throughput, low latency and high reliability, and the battery level of UE may affect user experience, because high throughput requires high power consumption on UE side. Therefore, considering limited radio resources and end-to-end QoS policy control from a system perspective, 5GS should be enhanced to support the trade-offs among throughput, latency, reliability, and device battery life.

For IoT devices, there are related power saving technologies such as MICO (Mobile Initiated Connection Only) mode and extended DRX (Discontinuous Reception), but these power saving modes may not be applicable to end devices such as smartphones.

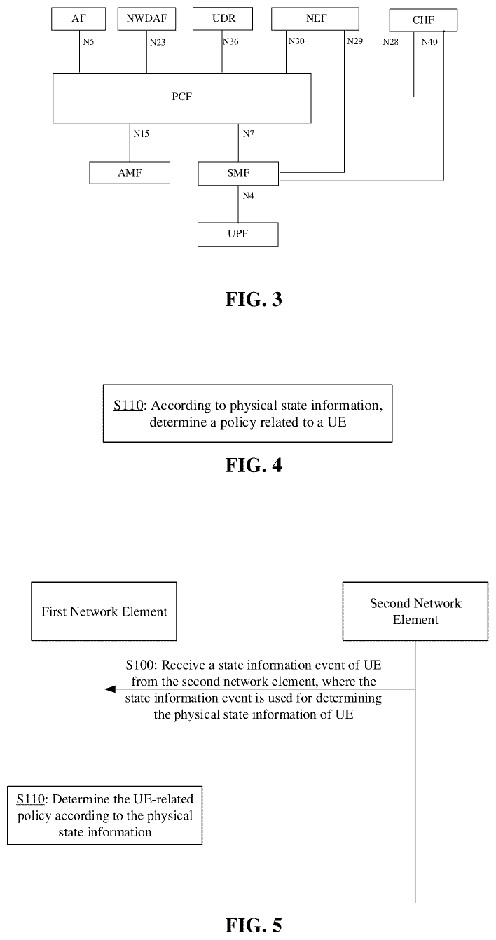

As shown in FIG. 4, an embodiment of this disclosure provides a policy processing method, which is performed by a first network element and includes followings.

In S110, a UE-related policy is determined according to physical state information.

The first network element may be various core network elements, for example, a network element, in the core network elements, that specifies UE-related policy. Exemplarily, the first network element may include but not limited to PCF.

UE here may be a smart phone, a tablet computer, a wearable device or the like, which are frequently used and/or consume a large amount of traffic.

The physical state information describes the physical state of UE, where the physical state is used for distinguishing network states or network connection states of UE.

The first network element determines a policy for controlling communication of UE according to the physical state information of UE. Exemplarily, the UE-related policy may include a policy related to a service of UE.

Using this UE-related policy to control the service flow of UE can reduce the problems of poor communication quality and poor service experience at UE, which are caused by the service flow provided simply according to high QoS that does not conform to the current physical state of UE. According to some embodiments of this disclosure, the first network element determines the UE-related policy according to the physical state information of UE. When allocating network resources for a service flow or session of UE and controlling the service flow or session according to the UE-related policy, the physical state of UE is taken into account, so as to at least alleviate the phenomenon that the network side allocates many resources for the service flow and/or session of UE but the actual QoS is poor caused by UE's own physical state, thereby, the one hand, improving the communication quality of UE, and on the other hand, reducing unnecessary waste of network resources.

In some embodiments, the physical state information is indicative of at least one of the following:
a current battery level of UE:
battery level change of UE:
a current temperature of UE:
temperature change of UE:
a current available memory capacity of UE; and
memory capacity change of UE.

UE contains a battery, whether a high-power consumption service flow is supported or whether an unnecessary high-power consumption thread is supported to be enabled may depend on the remaining power of the battery.

The current battery level may be a percentage of the remaining power of UE at the current moment.

The battery level change of UE may indicate the percentage of decrease or increase of the battery of UE, so the current remaining power of UE may be known in combination with a historical percentage determined at a historical timepoint.

The current temperature of UE may reflect a current power consumption rate of UE and/or a current heat dissipation of UE. If the current temperature of UE is very high, continuing to control the service flow of UE by using a policy that will cause UE to generate large power consumption may cause UE to further rise in temperature, and even cause problems such as downtime, battery aging, or equipment aging.

The temperature change of UE can be combined with a historical temperature of UE to determine the current temperature of UE.

The current available memory capacity of UE may be equal to a total memory capacity of UE minus a used memory capacity of UE.

The memory capacity change of UE can be combined with a known historical memory capacity to obtain the current memory capacity of UE.

In some embodiments, the physical state information may also indicate at least one of the following:
a rate of battery level change of UE:
a rate of memory capacity change of UE;
a rate of temperature change of UE;
a battery aging degree of UE; and
a model of UE.

The rate of battery level change can reflect the change of current battery capacity of UE. If the increase rate of the current battery level of UE is very high, it means that UE is being charged at a high power. At this time, it is feasible even if the first network element gives a UE-related policy that will increase the power consumption of UE.

The rate of memory capacity change of UE indicates, for example, if UE is stopping running of an application (APP) or loading an APP, the remaining capacity of UE at the current moment may be small or large, but the rate of the memory capacity change may be very high, such that the memory capacity may change greatly at the next monitoring moment. Accordingly, the rate of the memory capacity change of UE can also be used by the first network element to determine the UE-related policy.

The temperature change rate of UE can be predicted according to the temperature change curve before the current moment, or can be determined according to a deep learning neural network combined with the parameters such as the currently run application programs and/or configured threads of UE.

According to the temperature change rate, the temperature of UE in a certain period of future time can be predicted, and the first network element can determine the UE-related policy in combination with the current temperature of UE.

In some embodiments, the battery life of a new battery of UE is different from that of an old battery. Therefore, the aging degree of the battery of UE can also be used by the first network element to determine the UE-related policy.

The model of UE may reflect information such as the rated battery capacity and/or the total memory capacity and/or the heat dissipation capability of UE.

In some embodiments, the UE-related policy includes at least one of the following:
a policy for all services of the UE:
a policy for a single service of the UE; and
a policy for a service associated with one or more data protocol unit (PDU) sessions of the UE.

UE-related policies can be divided into multiple different levels according to the scope or quantity of services involved.

For example, after receiving the physical state information of UE sent by AMF, the first network element may determine, for all services of UE, a policy uniformly applicable to all services of UE according to the physical state information of UE sent by AMF.

For another example, after receiving the physical state information of UE sent by AMF, the first network element may respectively determine multiple policies for a single service of UE according to the physical state information of UE sent by AMF and characteristics of respective services of UE.

Exemplarily, the first network element receives the physical state information of UE sent by SMF which is mainly used for session control. At this time, according to session information provided by SMF, the policy for a service(s) associated with (involved in) one or more sessions in the session information provided by SMF can be determined according to the physical state information of UE.

To sum up, UE-related policies determined by the first network element may include policies at different levels. The specific level of policy determined by the first network element according to the physical state information of UE can be further determined according to the second network element providing the physical state information, or can be comprehensively determined according to the impact of the physical state information of UE on the service(s) and/or the service specificity of each service, which will not be described in detail here.

In some embodiments, qualities of service (QOS) corresponding to different UE-related policies are different:
and/or,
radio access technologies (RATs) corresponding to different UE-related policies are different.

For example, if the QoS is different, when UE initiates a corresponding service or responds to a corresponding service, the network may need to allocate network resources and implement data flow control according to the QoS. Different QoS may consume different network resources, and power consumption, memory occupation, or computing resource consumption of UE are also different. In other words, changes to the physical state of UE are different.

RATs supported by UE may include: 4G access, 5G access, 3G access, WLAN access, or the like. For different RATs, physical resource consumption such as power consumption and memory occupation after UE accesses the network is different, and changes to the physical state of UE are also different.

In some embodiments, as shown in FIG. 5, the policy processing method may include followings.

In S100, a state information event of UE is received from a second network element, where the state information event is used for determining the physical state information of UE.

The second network element can detect the physical state of UE, and send the physical state information of UE to the first network element based on the state information event. In this way, after receiving the state information event sent by the second network element, the first network element can consider re-determining the UE-related policy.

Exemplarily, the second network element may be various core network elements. Exemplarily, the second network element includes but not limited to: AMF and/or SMF. In some embodiments, the second network element may further include UPF.

Exemplarily, S100 may include:
receiving the state information event sent by AMF;
or,
receiving the state information event sent by SMF.

The state information event may be reported proactively by AMF or SMF, or may be reported based on a request or instruction of the first network element.

To sum up, the state information event comes from AMF and/or SMF, and the first network element can acknowledge the physical state information of UE based on the state information event. The physical state information may indicate a physical state of UE at the current moment or within the current period including the current moment. The physical state may be a power state, a memory state, a temperature state and/or a computing resource state other than a network state or a network connection state. The computing resource may include but not limited to resource state of a device(s) for computing and/or logic execution, such as central processing unit (CPU), microprocessor (MCU) and/or graphic processing unit (GPU), artificial intelligence (AI) chips, or the like.

In some embodiments, S110 may include:
determining the UE-related policy when receiving the state information event; or
determining, when receiving preset information, the UE-related policy according to the physical state information of the UE and the preset information;
or
determining, when receiving the physical state information, the UE-related policy according to the physical state information of the UE and preset information.

In some embodiments, once the first network element receives the state information event, it initially determines or re-determines the UE-related policy.

In some embodiments, only when the first network element receives the preset information, will it determine the UE-related policy according to the physical state information acquired in advance and the preset information. Alternatively, only when the first network element receives the preset information, will it request the physical state information of UE from the second network element and, then, determine the UE-related policy according to the physical state information provided by the second network element and the preset information acquired currently.

In some other embodiments, once the first network element receives the physical state information event, it will determine UE related policy the UE-related policy according to the physical state information event acquired currently, in combination with the preset information that is acquired in advance or determined temporarily and dynamically.

The preset information may be network-related information and/or information related to charging of UE.

Exemplarily, the preset information may be received from various databases, or received from UE or an access network element. For example, the preset information may be stored in UDR or user data management (UDM) or other databases. Exemplarily, the access network element may provide the preset information to the first network element according to the current usage state of its own air interface resources. For example, the database may provide charging information related to UE. UE may predict its own current network state according to its own sending state of data packets, so as to provide the preset information related to the network state to the first network element.

Actual parameter(s) of the preset information may include one or more. Accordingly, receiving the preset information may include: receiving all the preset information and/or receiving parameters in a minimum information set in the preset information. There may be one or more parameters in the minimum information set, and these parameters are necessary information for determining the UE-related policy. The above is only an example, and the specific implementation is not limited thereto.

In some embodiments, determining, when receiving the preset information, the UE-related policy according to the physical state information of UE and the preset information includes:
storing, when receiving the physical state information, the state information in a third network element; and
determining, when receiving the preset information, the UE-related policy according to the physical state information of the UE obtained from the third network element and the preset information.

If UE determines the UE-related policy after receiving the preset information, the time point when the first network element determines the preset information may not be synchronized with the time point of the physical state information of UE. Accordingly, if the physical state information is acquired first, the physical state information is stored in the third network element. The third network element can also be a core network element. Exemplarily, the third network element may be any database.

When the preset information is received, the previously stored physical state information is read from the third network element, and then the UE-related policy is determined based on the preset information and the physical state information.

Exemplarily, the third network element includes:
UDR:
or,
user data management (UDM);
or,
data storage network element.

The data storage network element may be a newly defined network element. For example, the data storage network element may also be a core network element or the like.

The preset information in the foregoing embodiments may be various information that can be used for determining the UE-related policy, for example, any information related to network resources, device type information of UE, and/or charging information of UE.

In some embodiments, the preset information includes but is not limited to at least one of the following:
payment information of a paying user;
network resource restriction status information; and
indication information on whether an actual QoS of UE reaches a target QoS.

According to the payment manner, paying users may include:
prepaid users, that is, users who need to pay in advance the fees for using services before using the services:
post-payment users, that is, users who are charged according to the usage of services after using the services.

For a prepaid user, the payment information may indicate but is not limited to at least one of the following: remaining fee information and/or information on services for which the prepaid fee is targeted.

For a post-payment user, the payment information may include: the user's overdraft limit, the user's overdraft service range, and/or the user's current overdraft amount.

If UE is transmitting a service flow, the transmitted service flow has an actual QoS, and the current QoS information may indicate the actual QoS or whether the actual QoS reaches a target QoS or the like. The target QoS is a currently valid QoS authorized to UE by the network side device. The actual QoS is the QoS actually measured and calculated according to the bandwidth resources allocated for UE and the like.

For example, the network resource restriction status information may indicate one of the following conditions:
network resources are not limited, that is, there are sufficient network resources available to be allocated to UE on the network side such as access network and/or core network:
network resources are limited, that is, network resources on the network side such as access network and/or core network are tight, and the network resources available to be allocated to UE may be relatively small, or there may be a delay in network resource allocation; and
network resource restriction level, which indicates the degree of restriction when the network resources are limited: the higher the network resource restriction level, the fewer the network resources can be allocated to UE.

The network resources include but are not limited to air interface resources and/or network slice resources, and the like.

In some embodiments, the preset information may also be other information that is not limited by the example here.

In some embodiments, determining the UE-related policy according to the physical state information of the UE includes:
determining a policy of UE according to the physical state information of UE and mapping relationship information, where the mapping relationship information is indicative of a correspondence relationship between different physical statuses of the UE and candidate policies; or
determining a policy of the UE according to the physical state information of the UE and auxiliary information sent by the UE.

For example, the mapping relationship information is pre-stored in the first network element, or stored in UDM or UDR.

After obtaining the physical state information of UE at the current moment, the first network element matches the physical state information with the information describing different physical statuses of UE in the mapping relationship information. If the matching is successful, a candidate policy corresponding to the successfully matched physical state in the mapping relationship information is the UE-related policy determined by the first network element.

In these embodiments, different UEs may have different mapping relationship information. For example, the mapping relationship information may be stored in database network elements such as UDM or UDR. The determination of mapping relationship information is performed comprehensively based on the model of UE, the payment type of UE, the aging degree of UE and the like.

In some embodiments, the UE-related policy is dynamically determined according to the auxiliary information provided by UE. The auxiliary information of UE may be determined according to the physical state of UE itself and/or the capability of UE. The auxiliary information may be sent by UE to the network side together with the physical state information, or may be carried in request information sent by UE to the network element on the network side. The request information may be the information that UE requests the network element on the network side to update its UE-related policy.

In some embodiments, the auxiliary information includes at least one of the following:
a policy suggested by UE:
QoS suggested by UE; and
an RAT suggested by UE.

In some embodiments, the auxiliary information may include a suggested policy, a suggested QoS, a suggested RAT or the like proposed based on the determination manner of the UE-related policy and the physical state of UE.

In some embodiments, the method further includes:
sending the physical state information to a fourth network element, where the physical state information is used by the fourth network element to determine a data policy for communicating with UE.

In some embodiments, the physical state information is sent to the fourth network element, and the fourth network element may be a network element belonging to the core network, or a network element not belonging to the core network. Exemplarily, the fourth network element may include but not limited to AF. In short, the fourth network element may be a network element having data flow interaction with UE. The data policy here may include any policy used by AF for data flow transmission between UE and AF.

As the physical state information is sent to the fourth network element, the fourth network element may also determine the data policy according to the physical state information, so that, from the data policy at the fourth network element to the control policy of the core network and access network on the data flow transmission of UE, the physical state of UE is taken into account. Accordingly, the policy consistency on data flow of UE, network and the peer end communicating with UE can be achieved based on the physical state of UE, thereby reducing resource waste and improving the communication quality of UE as much as possible.

In some embodiments, the data policy includes at least one of the following:
a coding policy; and
a data transmission policy.

The coding policy may indicate a coding rate used by AF to send data flow to UE and/or a coding rate used by UE to send data to AF.

The data transmission policy may indicate a data rate and the like.

As shown in FIG. 6, an embodiment of this disclosure provides a policy processing method, which is performed by a second network element and includes followings.

In S210, when determining that physical state information of UE changes, a state information event is sent to a first network element, where the physical state information indicated by the state information event is used by the first network element to determine a UE-related policy.

The second network element may be a network element capable of providing the physical state information to the first network element. Exemplarily, the second network element may be a core network element.

The second network element may proactively send the state information event to the first network element when monitoring a change in the physical state information of UE, or may send the physical state information event to the first network element upon receiving a sending request or instruction sent by the first network element and determining that the physical state information of UE changes. If there is no change in the physical state information of UE, it is sufficient to directly send an indication of no change. If the physical state information of UE changes, the state information event may need to carry information used by the first network element to determine the current physical state of UE.

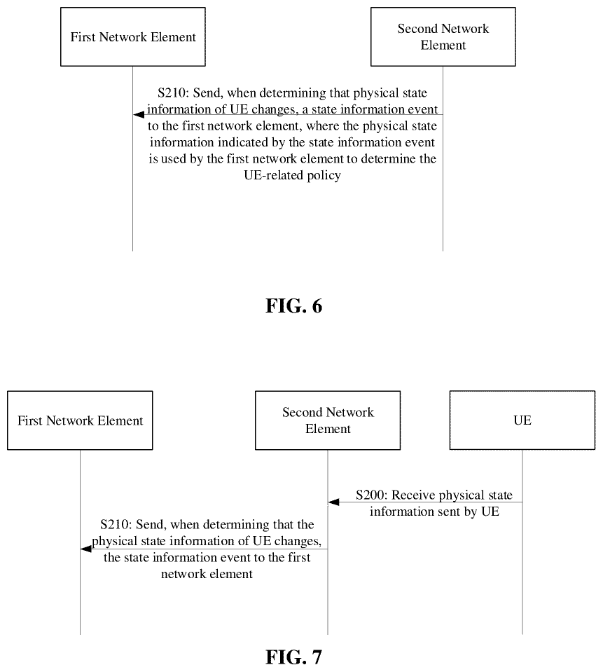

In some embodiments, as shown in FIG. 7, the method further includes followings.

In S200, the physical state information sent by UE is received, where the physical state information is determined by UE according to sensing data detected by its own sensor(s) and/or according to its own resource allocation state.

For example, UE determines its own current temperature according to its own temperature sensitive resistance, and/or determines the amount of temperature change based on historically reported temperature values.

For another example, UE may determine the current available memory capacity of UE according to its own allocated memory resources and total memory resources.

In some embodiments, the physical state information is indicative of at least one of the following:
a current battery level of UE;
battery level change of UE;
a current temperature of UE;
temperature change of UE;
a current available memory capacity of UE; and
memory capacity change of UE.

UE contains a battery, whether a high-power consumption service flow is supported or whether an unnecessary high-power consumption thread is supported to be enabled may depend on the remaining power of the battery.

The current battery level may be a percentage of the remaining power of UE at the current moment.

The battery level change of UE may indicate the percentage of decrease or increase of the battery of UE, so the current remaining power of UE may be known in combination with a historical percentage determined at a historical timepoint.

The current temperature of UE may reflect a current power consumption rate of UE and/or a current heat dissipation of UE. If the current temperature of UE is very high, continuing to control the service flow of UE by using a policy that will cause UE to generate large power consumption may cause UE to further rise in temperature, and even cause problems such as downtime, battery aging, or equipment aging.

The temperature change of UE can be combined with a historical temperature of UE to determine the current temperature of UE.

The current available memory capacity of UE may be equal to a total memory capacity of UE minus a used memory capacity of UE.

The memory capacity change of UE can be combined with a known historical memory capacity to obtain the current memory capacity of UE.

The second network element may receive a non-access stratum (NAS) message sent by UE, where the NAS message carries the physical state information. The NAS message includes but is not limited to a registration update request message, a session establishment message, a session update message, and/or a service request message and the like.

In some embodiments, the physical state information may also indicate at least one of the following:
a rate of battery level change of UE;
a rate of memory capacity change of UE;
a rate of temperature change of UE;
a battery aging degree of UE; and
a model of UE.

The rate of battery level change can reflect the change of current battery capacity of UE. If the increase rate of the current battery level of UE is very high, it means that UE is being charged at a high power. At this time, it is feasible even if the first network element gives a UE-related policy that will increase the power consumption of UE.

The rate of memory capacity change of UE indicates, for example, if UE is stopping running of an application (APP) or loading an APP, the remaining capacity of UE at the current moment may be small or large, but the rate of the memory capacity change may be very high, such that the memory capacity may change greatly at the next monitoring moment. Accordingly, the rate of the memory capacity change of UE can also be used by the first network element to determine the UE-related policy.

The temperature change rate of UE can be predicted according to the temperature change curve before the current moment, or can be determined according to a deep learning neural network combined with the parameters such as the currently run application programs and/or configured threads of UE.

According to the temperature change rate, the temperature of UE in a certain period of future time can be predicted, and the first network element can determine the UE-related policy in combination with the current temperature of UE.

In some embodiments, the battery life of a new battery of UE is different from that of an old battery. Therefore, the aging degree of the battery of UE can also be used by the first network element to determine the UE-related policy.

The model of UE may reflect information such as the rated battery capacity and/or the total memory capacity and/or the heat dissipation capability of UE.

In some embodiments, the UE-related policy includes at least one of the following:
a policy for all services of the UE;
a policy for a single service of the UE; and
a policy for a service associated with one or more data protocol unit (PDU) sessions of the UE.

For example, after receiving the physical state information of UE sent by AMF, the first network element may determine, for all services of UE, a policy uniformly applicable to all services of UE according to the physical state information of UE sent by AMF.

For another example, after receiving the physical state information of UE sent by AMF, the first network element may respectively determine multiple policies for a single service of UE according to the physical state information of UE sent by AMF and characteristics of respective services of UE.

Exemplarily, the first network element receives the physical state information of UE sent by SMF which is mainly used for session control. At this time, according to session information provided by SMF, the policy for a service(s) associated with (involved in) one or more sessions in the session information provided by SMF can be determined according to the physical state information of UE.

To sum up, UE-related policies determined by the first network element may include policies at different levels. The specific level of policy determined by the first network element according to the physical state information of UE can be further determined according to the second network element providing the physical state information, or can be comprehensively determined according to the impact of the physical state information of UE on the service(s) and/or the service specificity of each service, which will not be described in detail here.

In some embodiments, qualities of service (QOS) corresponding to different UE-related policies are different; and/or, RATs corresponding to different UE-related policies are different.

For example, if the QoS is different, when UE initiates a corresponding service or responds to a corresponding service, the network may need to allocate network resources and implement data flow control according to the QoS. Different QoS may consume different network resources, and power consumption, memory occupation, or computing resource consumption of UE are also different. In other words, changes to the physical state of UE are different.

RATs supported by UE may include: 4G access, 5G access, 3G access, WLAN access, or the like. For different RATs, physical resource consumption such as power consumption and memory occupation after UE accesses the network is different, and changes to the physical state of UE are also different.

In some embodiments, the second network element includes SMF or AMF. The second network element is exemplified here as SMF and AMF, but the specific implementation thereof is not limited to the SMF and AMF.

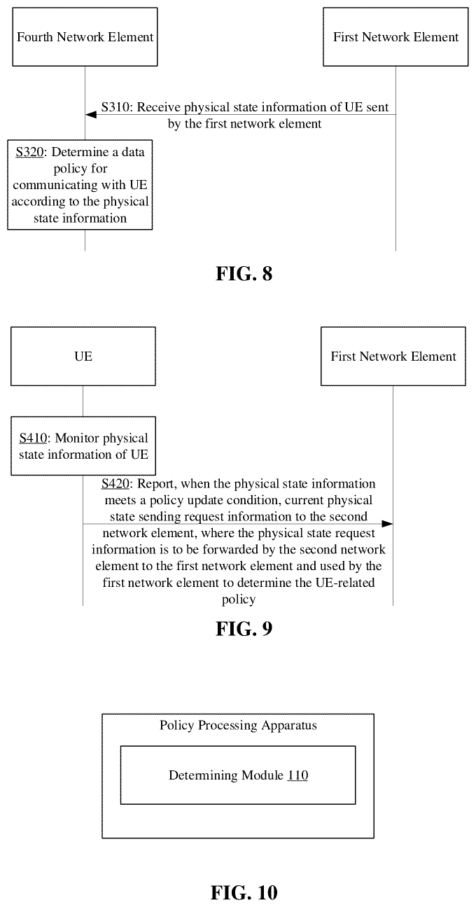

As shown in FIG. 8, an embodiment of this disclosure provides a policy processing method, which is performed by a fourth network element and includes followings.

In S310, physical state information of UE sent by a first network element is received.

In S320, a data policy for communicating with UE is determined according to the physical state information.

The fourth network element may be a network element that provides a data flow to UE and/or finally receives a data flow of UE. The fourth network element may be a core network element or a non-core network element. Exemplarily, the fourth network element includes but not limited to AF.

In some embodiments, the data policy includes at least one of the following:
a coding policy; and
a data transmission policy.

In some embodiments, the coding policy may indicate a coding rate used by AF to send data flow to UE and/or a coding rate used by UE to send data to AF. The data transmission policy may indicate a data rate and the like.

The above are only examples of data policies, and specific implementations thereof are not limited to the above examples.

As shown in FIG. 9, an embodiment of this disclosure provides a policy processing method, which is performed by UE and includes followings.

In S410, physical state information of UE is monitored.

In S420, when the physical state information meets a policy update condition, current physical state information is reported to the second network element, where the physical state information is to be forwarded by the second network element to a first network element and used by the first network element to determine a UE-related policy.

In some embodiments, UE obtains the physical state information by monitoring the physical state through its own sensors, or determines its own physical state information according to its own resource allocation.

For example, the physical state information monitored by UE may be reported to the second network element. For example, the physical state information may be reported to the second network element through various NAS messages. Upon being reported to the second network element, the physical state information may be forwarded by the second network element to the first network element and used by the first network element to determine the UE-related policy. Exemplarily, after receiving the physical state information sent by UE, the second network element sends the physical state information to the first network element by means of a state information report.

In some embodiments, after UE detects its own physical state information and finds that its own physical state information meets the policy update condition, it proactively sends the physical state information to the first network element through the second network element, and the physical state information can be used by the first network element to determine the UE-related policy for UE.

Exemplarily, the physical state information meeting the policy update condition may include at least one of the following:
a change amount of physical state indicated by the physical state information reaches an update threshold: for example, the change in remaining power, the change in remaining memory, and/or the change in temperature reaches a corresponding threshold(s); and
a change tendency of physical state indicated by the physical state information is different from a historical change tendency of UE's physical state: for example, at a historical moment, a change tendency of UE's temperature is decreasing, while a detected change tendency of UE's temperature at the current moment is rising: for another example, at a historical moment, the remaining battery level of UE decreases, but the detected remaining battery level of UE increases at the current moment.

To sum up, UE can proactively send request information to the first network element when it determines that its own physical state change meets the policy update condition according to the physical state information, and the request information can at least trigger the first network element to re-determine a UE-related policy for UE.

In some embodiments, the physical state information is indicative of at least one of the following:
a current battery level of UE:
battery level change of UE:
a current temperature of UE:
temperature change of UE:
a current available memory capacity of UE; and
memory capacity change of UE.

In some embodiments, the UE-related policy includes at least one of the following:
a policy for all services of the UE:
a policy for a single service of the UE; and
a policy for a service associated with one or more data protocol unit (PDU) sessions of the UE.

In some embodiments, qualities of service (QOS) corresponding to different UE-related policies are different; and/or, RATs corresponding to different UE-related policies are different.

In some embodiments, the request information only includes a policy update request without auxiliary information. Accordingly, after receiving the request information, the first network element may need to obtain information for determining the UE-related policy from the second network element and the like.

In some embodiments, the request information does not contain auxiliary information. The request information may be a manner of triggering the first network element to re-determine the UE-related policy for UE.

An embodiment of this disclosure provides an information processing method, which may be performed by UE and include:
providing auxiliary information to the second network element, where the auxiliary information is to be forwarded by the second network element to the first network element before being used by the first network element to determine the UE-related policy for UE. This information processing method can be implemented alone or in combination with the information processing methods of the foregoing embodiments.

Exemplarily, the auxiliary information may be reported to the second network element together with the physical state information in the foregoing embodiments, or the auxiliary information may be reported to the second network element separately. For example, the auxiliary information may be carried in a request message sent by UE, where the request message may be used to request the network side to update the UE-related policy of UE.

In some embodiments, the auxiliary information includes at least one of the following:
a policy suggested by UE;
a QoS suggested by UE; and
an RAT suggested by UE.

Here, UE can provide, according to the physical state information monitored by itself, the auxiliary information for the first network element to determine the UE-related policy, thereby facilitating the first network element to dynamically determine the UE-related policy for UE according to the auxiliary information.

An embodiment of this disclosure provides a policy processing method, which defines the physical state of UE, such as battery life and/or battery level, temperature, memory usage, and the like, as a trigger or policy decision considerations for the access-related policy or the non-access-related policy.

PCF obtains the physical state information of UE from AMF or SMF, for example, the battery level change. For example, when PCF receives an event of current battery level of UE, PCF determines a policy of UE according to the current battery level of UE, for example, a QoS for low or very low battery.

When PCF receives the battery level event of UE from AMF, PCF may evaluate policies for all services of UE.

When PCF receives the battery level event of UE from SMF, PCF may evaluate a policy for a specific service of UE or a policy for a specific PDU session.

As far as the power consumption of a specific service is concerned, a mapping relationship between multiple policy levels and multiple battery levels of UE can be defined in advance. Then, according to the current physical state of UE and the mapping relationship, a UE-related policy suitable for the current physical state of UE can be determined. Alternatively, a UE-related policy can be dynamically determined based on auxiliary information provided by UE and/or a request from UE.

The UE physical state of UE, such as UE's battery level, temperature, memory usage, and the like, can be directly used for determining the UE-related policy, or can be stored in UDR before being used in combination with other information to determine the policy. Other information here includes but is not limited to: the network resource restriction status, guaranteed flow bit rate (GFBR) QoS, payment information, and the like.

As shown in FIG. 10, an embodiment of this disclosure provides a policy processing apparatus, where the apparatus includes:
a determining module 110, configured to determine a UE-related policy according to physical state information of UE.

The policy processing apparatus may be included in the first network element.

In some embodiments, the determination module 110 may be a program module which, upon being executed by a processor in the first network element, is to determine the UE-related policy of UE according to the physical state information of UE.

In some other embodiments, the determining module 110 may be a combination of hardware and software, where the combination of hardware and software includes but is not limited to various programmable arrays, and the programmable arrays include but not limited to field programmable arrays and/or complex programming arrays.

In still some embodiments, the determining module 110 may also be a pure hardware module, where the pure hardware module includes but is not limited to an application specific integrated circuit.

In some embodiments, the physical state information is indicative of at least one of: a current battery level of UE;
battery level change of UE:
a current temperature of UE;
temperature change of UE:
a current available memory capacity of UE; and
memory capacity change of UE.

In some embodiments, the UE-related policy includes at least one of:
a policy for all services of UE:
a policy for a single service of UE; and
a policy for a service associated with one or more PDU sessions of the UE.

In some embodiments, qualities of service (QOS) corresponding to different UE-related policies are different:
and/or,
RATs corresponding to different UE-related policies are different.

In some embodiments, the apparatus includes:
a receiving module, configured to receive a state information event of the UE from a second network element, where the state information event is used for determining the physical state information of the UE.

In some embodiments, the receiving module is configured to receive the state information event sent by AMF; or receive the state information event sent by SMF.

In some embodiments, the determining module 110 is configured to determine the UE-related policy when receiving the state information event: or, determine, when receiving preset information, the UE-related policy according to the physical state information of UE and the preset information: or, determine, when receiving the physical state information, the UE-related policy according to the physical state information of UE and the preset information.

In some embodiments, the determining module 110 is configured to store, when receiving the physical state information, the state information in a third network element; and determine, when receiving the preset information, the UE-related policy according to the physical state information of UE obtained from the third network element and the preset information.

In some embodiments, the third network element includes:
UDR;
or,
UDM;
or,
data storage network element.

The preset information in the foregoing embodiments may be various information that can be used for determining the UE-related policy, for example, any information related to network resources, device type information of UE, and/or payment information of UE.

In some embodiments, the preset information includes but is not limited to at least one of:
payment information of paying users;
network resource restriction status information; and
indication information on whether an actual QoS of the UE reaches a target QoS.

In a specific embodiment, the preset information may also be other information that is not limited by the example here.

In some embodiments, determining the UE-related policy according to the physical state information of UE includes:
determining a policy of UE according to the physical state information of the UE and mapping relationship information, where the mapping relationship information is indicative of a correspondence relationship between different physical statuses of UE and candidate policies: or
determining a policy of UE according to the physical state information of UE and auxiliary information sent by UE.

In some embodiments, the auxiliary information includes at least one of:
a policy suggested by UE;
a QoS suggested by UE; and
an RAT suggested by UE.

In some embodiments, the apparatus further includes:
a sending module, configured to send the physical state information to a fourth network element, where the physical state information is used by the fourth network element to determine a data policy for communicating with the UE.

In some embodiments, the data policy includes at least one of:
a coding policy; and
a data transmission policy.

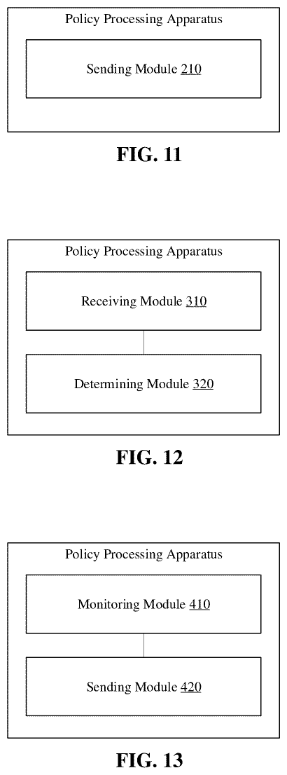

As shown in FIG. 11, an embodiment of this disclosure provides a policy processing apparatus, where the apparatus includes:
a sending module 210, configured to send, when determining that physical state information of UE changes, a state information event to a first network element, where the physical state information indicated by the state information event is used by the first network element to determine a UE-related policy.

The policy processing apparatus may be included in the second network element.

In some embodiments, the sending module 210 may include a program module which, upon being executed by a processor, is used for implementing the sending of the state information event.

In other embodiments, the sending module 210 may include a combination of hardware and software, where the combination of hardware and software includes, but is not limited to various programmable arrays, and the programmable arrays may include field programmable arrays and/or complex programmable arrays.

In still some embodiments, the sending module 210 may include a pure hardware module, where the pure hardware module may include but not limited to an application specific integrated circuit.

In some embodiments, the physical state information is indicative of at least one of:
a current battery level of UE;
battery level change of UE;
a current temperature of UE;
temperature change of UE;
a current available memory capacity of UE; and
memory capacity change of UE.

In some embodiments, the UE-related policy includes at least one of:
a policy for all services of UE;
a policy for a single service of UE; and
a policy for a service associated with one or more PDU sessions of the UE.

In some embodiments, qualities of service (QOS) corresponding to different UE-related policies are different:
and/or,
RATs corresponding to different UE-related policies are different.

In some embodiments, the second network element includes SMF or AMF.

As shown in FIG. 12, an embodiment of this disclosure provides a policy processing apparatus, where the apparatus includes:
a receiving module 310, configured to receive physical state information of UE sent by a first network element; and
a determining module 320, configured to determine a data policy for communicating with UE according to the physical state information.

The policy processing apparatus may be included in a fourth network element, where the fourth network element includes but not limited to AF.

In some embodiments, the receiving module 310 may include a program module which, upon being executed by a processor, is used for implementing the receiving of the physical state information and the determination of the data policy.

In some other embodiments, the receiving module 310 may include a combination of hardware and software, where the combination of hardware and software includes but is not limited to various programmable arrays, and the programmable arrays may include field programmable arrays and/or complex programmable arrays.

In still some embodiments, the receiving module 310 may include a pure hardware module, where the pure hardware module may include but not limited to an application specific integrated circuit.

In some embodiments, the data policy includes at least one of:
a coding policy; and
a data transmission policy.

As shown in FIG. 13, an embodiment of this disclosure provides a policy processing apparatus, where the apparatus includes:
a monitoring module 410, configured to monitor physical state information of UE; and
a sending module 420, configured to report, when the physical state information meets a policy update condition, the physical state information to a second network element, where the physical state information is to be forwarded by the second network element to a first network element and used by the first network element to determine a UE-related policy.

The policy processing apparatus may be included in UE.

In some embodiments, the monitoring module 410 and the sending module 420 may include a program module which, upon being executed by a processor, is configured to monitor the physical state information and send the request information.

In some other embodiments, the monitoring module 410 and the sending module 420 may include a combination of hardware and software, where the combination of hardware and software includes but is not limited to various programmable arrays, and the programmable array may include field programmable arrays and/or complex programmable arrays.

In some other embodiments, the monitoring module 410 and the sending module 420 may include a pure hardware module, where the pure hardware module may include but not limited to an application specific integrated circuit.

In some embodiments, the physical state information is indicative of at least one of:
a current battery level of UE:
battery level change of UE:
a current temperature of UE:
temperature change of UE:
a current available memory capacity of UE; and
memory capacity change of UE.

In some embodiments, the UE-related policy includes at least one of:
a policy for all services of UE:
a policy for a single service of UE; and
a policy for a service associated with one or more PDU sessions of the UE.

In some embodiments, qualities of service (QOS) corresponding to different UE-related policies are different:
and/or,
RATs corresponding to different UE-related policies are different.

In some embodiments, the request information includes auxiliary information, where the auxiliary information is used by the first network element to determine the UE-related policy for UE.

In some embodiments, the auxiliary information includes at least one of:
a policy suggested by UE:
a QoS suggested by UE; and
an RAT suggested by UE.

Some embodiments of this disclosure provide a communication device, including:
a memory, configured to store executable instructions of a processor; and
a processor, respectively connected to the memory,
where the processor is configured to implement the policy processing method according to any technical solution described above.

Here, the processor may include various types of storage medium, including non-transitory computer storage medium which can continue to memorize and store information thereon after the communication device is powered off.

Here, the communication device includes: a UE or a network element, and the network element may be any one of the foregoing first to fourth network elements.

The processor may be connected to the memory through a bus and the like, for reading the executable program stored on the memory, so as to implement, for example, at least one of the methods shown in FIG. 4 to FIG. 9.

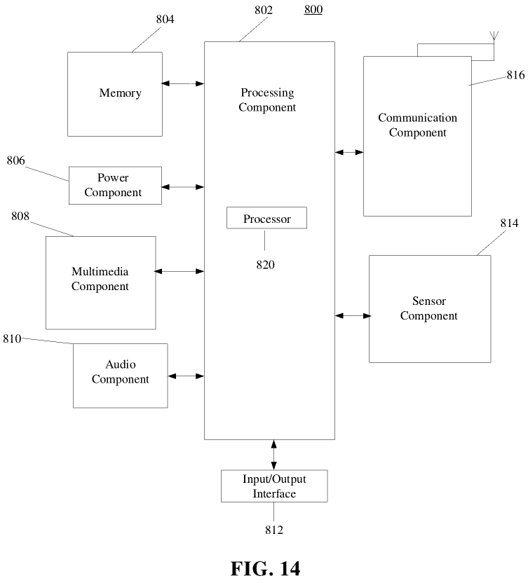

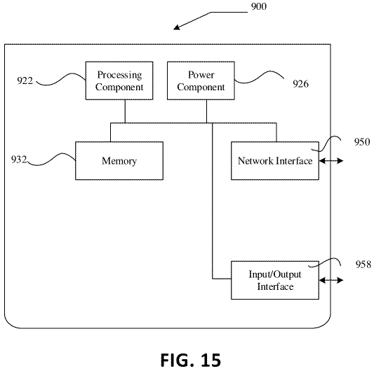

FIG. 14 is a block diagram of a UE 800 according to an exemplary embodiment. For example, UE 800 may be a mobile phone, a computer, a digital broadcast terminal, a messaging device, a game console, a tablet device, a medical device, a fitness device, a personal digital assistant, and the like.

Referring to FIG. 14, UE 800 may include one or more of the following components: processing component 802, memory 804, power component 806, multimedia component 808, audio component 810, input/output (I/O) interface 812, sensor component 814, and communication component 816.

The processing component 802 generally controls the overall operation of UE 800, such as operations associated with display, phone calls, data communications, camera operations, and recording operations. The processing component 802 may include one or more processors 820 to execute instructions to perform all or some of the steps of the methods described above. Additionally, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support operations at UE 800. Examples of such data include instructions, contact data, phonebook data, messages, pictures, videos, and the like for any application or method operating on UE 800. The memory 804 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 806 provides power to various components of UE 800. The power components 806 may include a power management system, one or more power sources, and other components associated with generating, managing, and distributing power to UE 800.

The multimedia component 808 includes a screen that provides an output interface between UE 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 808 includes a front camera and/or a rear camera. When UE 800 is in an operation mode, such as a shooting mode or a video mode, the front camera and/or the rear camera may receive external multimedia data. Each of the front and rear cameras may be a fixed optical lens system or have focal length and optical zoom capability.

The audio component 810 is configured to output and/or input audio signals. For example, the audio component 810 includes a microphone (MIC) that is configured to receive external audio signals when UE 800 is in operating modes, such as calling mode, recording mode, and voice recognition mode. The received audio signal may be further stored in the memory 804 or transmitted via the communication component 816. In some embodiments, the audio component 810 also includes a speaker for outputting audio signals.

The I/O interface 812 provides an interface between the processing component 802 and a peripheral interface module, which may be a keyboard, a click wheel, a button, or the like. These buttons may include, but are not limited to: home button, volume buttons, start button, and lock button.

The sensor assembly 814 includes one or more sensors for providing state assessments of various aspects of UE 800. For example, the sensor assembly 814 can detect the open/closed state of UE 800, the relative positioning of components, such as the display and keypad of UE 800. The sensor assembly 814 can also detect a change in the position of UE 800 or a component of UE 800, the presence or absence of user contact with UE 800, the orientation or acceleration/deceleration of UE 800, and the temperature change of UE 800. The sensor assembly 814 may include a proximity sensor configured to detect the presence of nearby objects in the absence of any physical contact. The sensor assembly 814 may also include a light sensor, such as a CMOS or CCD image sensor, for use in imaging applications. In some embodiments, the sensor assembly 814 may also include an acceleration sensor, a gyroscope sensor, a magnetic sensor, a pressure sensor, or a temperature sensor.

The communication component 816 is configured to facilitate wired or wireless communication between UE 800 and other devices. UE 800 may access wireless networks based on communication standards, such as WiFi, 2G or 3G, or a combination thereof. In some embodiments, the communication component 816 receives broadcast signals or broadcast related information from an external broadcast management system via a broadcast channel. In some embodiments, the communication component 816 also includes a near field communication (NFC) module to facilitate short-range communication. For example, the NFC module may be implemented based on radio frequency identity (RFID) technology, infrared data association (IrDA) technology, ultra-wideband (UWB) technology, Bluetooth (BT) technology and other technologies.

In some embodiments, UE 800 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component, which are configured to perform the forgoing methods.

In some embodiments, there is also provided a non-transitory computer-readable storage medium including instructions, such as the memory 804 including instructions, executable by the processor 820 of UE 800 to perform the method described above. For example, the non-transitory computer-readable storage medium may be ROM, random access memory (RAM), CD-ROM, magnetic tape, floppy disk, optical data storage device, and the like.

As shown in FIG. 15, an embodiment of this disclosure shows a structure of an access device. For example, the communication device 900 may be provided as a network side device. The communication device may be various network elements such as the aforementioned access network element and/or core network element.

Referring to FIG. 15, the communication device 900 includes a processing component 922, which further includes one or more processors, and a memory resource represented by a memory 932 for storing instructions executable by the processing component 922, such as application programs. The application program stored in memory 932 may include one or more modules each corresponding to a set of instructions. In addition, the processing component 922 is configured to execute instructions, so as to implement any of the foregoing methods applied to the access device, for example, the method shown in any one of FIG. 4 to FIG. 9.

The communication device 900 may also include a power component 926 configured to perform power management of the communication device 900, a wired or wireless network interface 950 configured to connect the communication device 900 to a network, and an I/O interface 958. The communication device 900 can operate based on an operating system stored in the memory 932, such as Windows Server™, Mac OS X™, Unix™, Linux™, FreeBSD™ or the like.

Other embodiments of the invention will be readily apparent to those skilled in the art from consideration of the specification and practice of the invention disclosed herein. This disclosure is intended to cover any modification, use or adaptation of the present invention, which follow the general principles of the present invention and include common knowledge or conventional technical means in the art not disclosed in this disclosure. The specification and examples are to be considered exemplary only, with a true scope and spirit of the invention being indicated by the following claims.

It should be understood that the present invention is not limited to the precise constructions which have been described above and shown in the accompanying drawings, and various modifications and changes may be made without departing from the scope thereof. The scope of the invention is limited only by the appended claims.

1. A policy processing method, performed by a first network element, comprising:
determining a policy related to user equipment (UE) according to physical state information of the UE.

2. The method according to claim 1, wherein the physical state information is indicative of at least one of:
a current battery level of the UE;
battery level change of the UE;
a current temperature of the UE;
temperature change of the UE;
a current available memory capacity of the UE; and
memory capacity change of the UE.

3. The method according to claim 1, wherein the policy related to the UE comprises at least one of:
a policy for all services of the UE;
a policy for a single service of the UE; and
a policy for a service associated with one or more data protocol unit (PDU) sessions of the UE.

4. The method according to claim 1, wherein,
different policies related to the UE correspond to different qualities of service (QOS) or different radio access technologies (RATs).

5. The method according to claim 1, further comprising:
receiving a state information event of the UE from a second network element, wherein the state information event is used for determining the physical state information of the UE.

6. The method according to claim 5, wherein receiving the event from the second network element comprises one of:
receiving the state information event sent by an access management function (AMF); or
receiving the state information event sent by a session management function (SMF).

7. The method according to claim 5, wherein determining the policy related to the UE according to the physical state information of the UE comprises one of:
determining the policy related to the UE when receiving the state information event;
determining, when receiving preset information, the policy related to the UE according to the physical state information of the UE and the preset information; or
determining, when receiving the physical state information, the policy related to the UE according to the physical state information of the UE and preset information.

8. The method according to claim 7, wherein determining, when receiving the preset information, the policy related to the UE according to the physical state information of the UE and the preset information comprises:
storing, when receiving the physical state information, the physical state information in a third network element; and
determining, when receiving the preset information, the policy related to the UE according to the physical state information of the UE obtained from the third network element and the preset information.

9. The method according to claim 8, wherein the third network element comprises one of:
a unified data repository (UDR);
a user data management (UDM); or
a data storage network element.

10. The method according to claim 8, wherein the preset information comprises at least one of:
payment information of a paying user;
network resource restriction status information; and
indication information on whether an actual QoS of the UE reaches a target QoS.

11. The method according to claim 1, wherein determining the policy related to the UE according to the physical state information of the UE comprises one of:
determining the policy related to the UE according to the physical state information of the UE and mapping relationship information, wherein the mapping relationship information is indicative of a correspondence relationship between different physical statuses of the UE and candidate policies; or
determining a policy of the UE according to the physical state information of the UE and auxiliary information sent by the UE.

12. The method according to claim 11, wherein the auxiliary information comprises at least one of:
a policy suggested by the UE;
a QoS suggested by the UE; and
an RAT suggested by the UE.

13. The method according to claim 1, further comprising:
sending the physical state information to a fourth network element, wherein the physical state information is used by the fourth network element to determine a data policy for communicating with the UE.

14. The method according to claim 13, wherein the data policy comprises at least one of:
a coding policy; and
a data transmission policy.

15. A policy processing method, performed by a second network element, comprising:
sending, when determining that physical state information of user equipment (UE) changes, a state information event to a first network element, wherein the physical state information indicated by the state information event is used by the first network element to determine a policy related to the UE.

16.-21. (canceled)

22. A policy processing method, performed by user equipment (UE), comprising:
monitoring physical state information of the UE; and
reporting, when the physical state information meets a policy update condition, the physical state information to a second network element, wherein the physical state information is to be forwarded by the second network element to a first network element and used by the first network element to determine a policy related to the UE.

23.-25. (canceled)

26. The method according to claim 22, further comprising:
providing auxiliary information to the second network element, wherein the auxiliary information is to be forwarded by the second network element to the first network element and used by the first network element to determine the policy related to the UE for the UE.

27.-56. (canceled)

57. A first network device, comprising:
a processor;
a transceiver; and
a memory storing a program executable by the processor,
wherein the processor is configured to perform the method according to claim 1.

58. A second network device, comprising:
a processor;
a transceiver; and
a memory storing a program executable by the processor,
wherein the processor is configured to perform the method according to claim 15.

59. A user equipment (UE), comprising:
a processor;
a transceiver; and
a memory storing a program executable by the processor,
wherein the processor is configured to perform the method according to claim 22.
